(19) United States
(12) Patent Application Publication
(10) Pub. No.: US 2010/0299738 A1
(43) Pub. Date: Nov. 25, 2010

(54) CLAIMS-BASED AUTHORIZATION AT AN IDENTITY PROVIDER

(75) Inventor: Mark Wahl, Austin, TX (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/468,065

(22) Filed: May 19, 2009

(51) Int. Cl. H04L 9/32; G06F 21/00

(52) U.S. Cl. 726/9; 713/170; 726/4; 713/175

(57) ABSTRACT

Techniques are described herein for managing access to services (e.g., Web sites, applications, results of executable operations, etc.) that are provided by relying parties. A relying party is a processing system that relies on an identity provider to authenticate an entity (e.g., user or software application) that attempts to access a service provided by the relying party. The identity provider is a processing system that is configured to perform authentication and authorization operations with respect to the entity. The identity provider generates a claim that indicates access rights of the entity with respect to the relying party. The identity provider provides the claim to the relying party via a user system or via a direct or indirect link that bypasses the user system. The relying party determines whether to allow the entity to access the service based on the access rights indicated by the claim.

### BACKGROUND

In a computer network, a user may wish to access services provided by a relying party, which may be located elsewhere in the network. A relying party traditionally is a computer (e.g., a server) or other processing system that relies on an identity provider to authenticate a user (e.g., verify the user's identity) who attempts to access a service provided by the relying party, rather than authenticating the user directly. The relying party often requires both authentication of the user and authorization of the user (e.g., verification that the user is allowed to access the service) in order for the user to be granted access to the service.

A variety of protocols have been developed for authenticating and authorizing users in computer networks, though each protocol has its limitations. In the 1990s, prior to the use of Web technologies, most protocols for performing authentication and authorization focused on controlling employees' access to internal resources of a corporate network. For instance, the Kerberos® protocol, which was developed by the Massachusetts Institute of Technology, allows a requesting client (e.g., a software application running on a user's desktop) to authenticate itself to a relying party without having to reveal the user's password to the relying party. Rather, a Kerberos® server is utilized to authenticate the user and to inform the relying party of the user's authenticity. Upon receiving an indication that the user is authenticated, the relying party performs an authorization operation to determine whether the client is allowed to access the services of the relying party. Accordingly, per-user data is maintained at both the Kerberos® server and the relying party, which may increase the possibility of inconsistencies and/or data leakage. As Web technologies (e.g., e-commerce) became more common, the Kerberos® protocol fell out of favor due primarily to its inability to adequately support the complexities and increased demands of the Web technologies.

Web Access Management protocols have been developed to address the shortcomings of the Kerberos® protocol. However, the authentication and authorization functionality in such protocols traditionally is provided by the relying party, such that each service includes its own code for providing the authentication and authorization functionality. Creating the code for each service often consumes substantial resources. One alternative is to introduce an access server that can be accessed through a plug-in to the relying party for performing the authentication and authorization functions. However, in accordance with this alternative, the access server often stores identifying information pertaining to each user that can potentially use the services of the relying party, which may consume substantial resources of the access server.

### SUMMARY

Various approaches are described herein for, among other things, managing access to services (e.g., Web sites, applications, results of executable operations, etc.) provided by relying parties. Relying parties are computers (e.g., servers) or other processing systems, each of which includes at least one processor, that rely on an identity provider to authenticate entities (e.g., users or software applications) that attempt to access services provided by the relying parties. The identity providers described herein are computers (e.g., servers) or other processing systems, each of which includes at least one processor, that are configured to perform authentication and authorization operations with respect to entities that attempt to access the services provided by the relying parties.

An identity provider generates claims that can be used by a relying party to determine whether entities are authorized to access a service provided by the relying party. A claim is an indicator that specifies information regarding an entity with respect to a service. For example, the identity provider may generate a claim that indicates access rights of the entity with respect to the relying party. The identity provider may send the claim to the relying party to inform the relying party of the entity's access rights. In another example, the identity provider may generate a claim that indicates steps that may be performed by a user in order for the entity to obtain authorization to access the service.

An example method is described in which a claim is generated at an identity provider using processor(s) of the identity provider. The claim includes an indicator that specifies access rights of an entity with respect to a relying party. The indicator is provided to the relying party, so that the relying party may determine whether the entity is authorized to utilize a service provided by the relying party.

Another example method is described in which an indicator is received by a relying party from an identity provider. The indicator specifies access rights of an entity with respect to the relying party. Based on the indicator, processor(s) of the relying party are used to make a determination as to whether the entity is authorized to utilize a service provided by the relying party.

An example identity provider is described that includes an authentication module, a claim generation module, and an indicator providing module. The authentication module is configured to authenticate an entity. The claim generation module is configured to generate a claim that includes an indicator, which specifies access rights of the entity with respect to a relying party. The indicator providing module is configured to provide the indicator to the relying party, enabling the relying party to determine whether the entity is authorized to utilize a service provided by the relying party.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Moreover, it is noted that the invention is not limited to the specific embodiments described in the Detailed Description and/or other sections of this document. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the present invention and, together with the description, further serve to explain the principles involved and to enable a person skilled in the relevant art(s) to make and use the disclosed technologies.

FIG. 1 is a block diagram of an example claims-based identity metasystem in accordance with an embodiment.

FIG. 2 is a block diagram of an example implementation of an identity provider shown in FIG. 1 in accordance with an embodiment.

FIG. 3 is a unified modeling language (UML) diagram of an example data model of an authorization database shown in FIG. 2 in accordance with an embodiment.

FIG. 4 depicts a flowchart of a method for performing claims-based authorization in accordance with an embodiment.

FIG. 5 is a block diagram of an example implementation of a security token service module shown in FIG. 2 in accordance with an embodiment.

FIG. 6 depicts a flowchart of a method for verifying authorization in accordance with an embodiment.

FIG. 7 is a block diagram of an example implementation of a relying party shown in FIG. 1 in accordance with an embodiment.

FIG. 8 depicts a flowchart of a method for centralizing authentication and authorization functionality at an identity provider in accordance with an embodiment.

FIG. 9 is a block diagram of an example implementation of an administration (admin) system shown in FIG. 1 in accordance with an embodiment.

FIG. 10 depicts an example computer in which embodiments may be implemented.

The features and advantages of the disclosed technologies will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. INTRODUCTION

The following detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the relevant art(s) to implement such feature, structure, or characteristic in connection with other embodiments whether or not explicitly described.

### II. EXAMPLE EMBODIMENTS FOR CLAIMS-BASED AUTHORIZATION AT AN IDENTITY PROVIDER

The detailed description begins with a high-level discussion of the environment in which example structural and operational embodiments may be implemented, followed by a more detailed discussion of the example structural and operational embodiments. Internet identity systems control access of entities (e.g., users or software applications) to services that are available on a network. An identity metasystem is an infrastructure that enables Internet identity systems that are based on different platforms to operate on the same network. The identity metasystem provides, for example, a consistent user interface for the Internet identity systems.

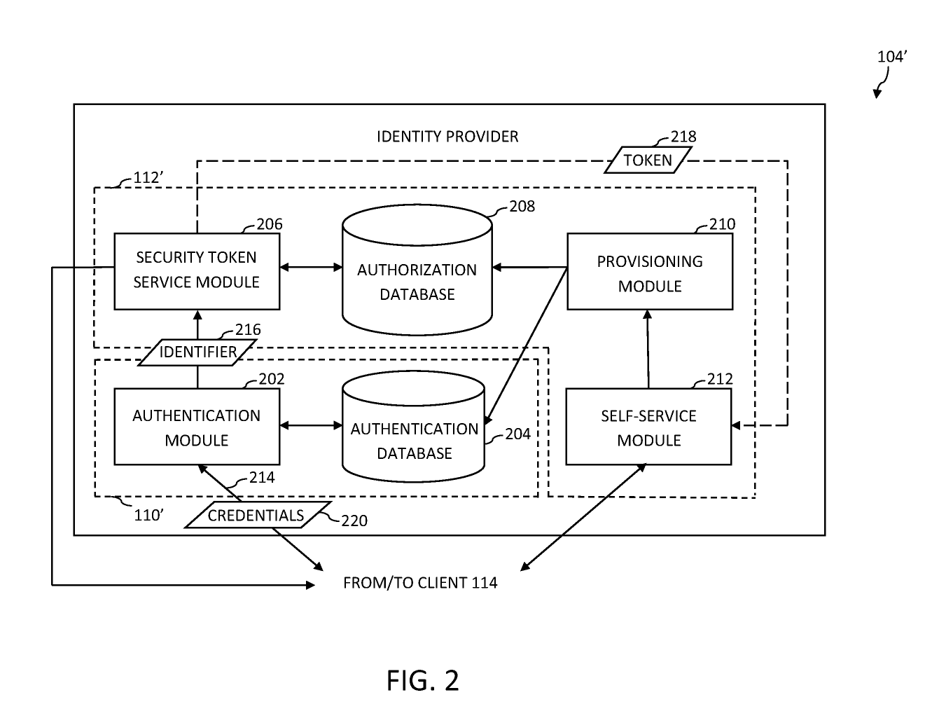

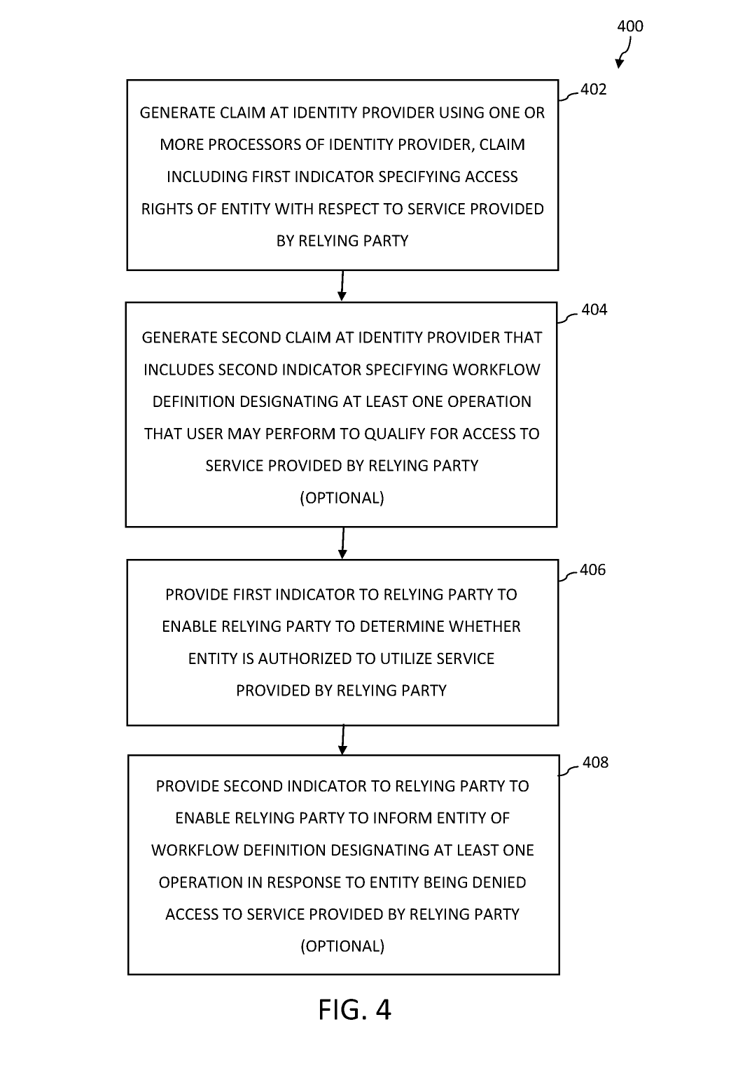

The identity metasystem may use any of a variety of security features to control access to services that are available on the network. One such security feature is a claim. A claim is an indicator that specifies information regarding an entity with respect to a service that is available in the identity metasystem. For example, the claim may specify that the entity is (or is not) authorized to access the service. In another example, the claim may include a workflow definition that specifies the steps that may be taken by the entity to obtain access to the service. The example claims described herein are provided for illustrative purposes and are not intended to be limiting. For instance, a claim may specify any suitable information regarding an entity with respect to a service. Accordingly, a claim may be used to determine access rights of the entity with respect to the service, to determine the steps that may be taken by the entity to obtain access to the service, etc. Further discussion of claims is provided below with reference to FIGS. 2 and 4, for example. An identity metasystem that uses claims, rather than more traditional means (e.g., user names and passwords), to authorize entities is referred to as a “claims-based” identity metasystem. Accordingly, the environment in which example embodiments may be implemented may be described as a claims-based identity metasystem.

Some example structural components and corresponding functionality of the claims-based identity metasystem will now be discussed. An identity provider is a computer (e.g., a server) or other processing system, including one or more processors, which is configured to perform authentication and authorization operations with respect to entities that are attempting to access service(s) of a relying party. For example, the authentication operations may include verifying the entities' respective identities. In another example, the authorization operation may include verifying that the entities are allowed to access service(s) that the entities are attempting to access. With respect to the authorization operations, the identity provider generates at least one claim for each entity that is attempting to access a service of the relying party. A relying party is a computer (e.g., a server) or other processing system, including one or more processors, which relies on an identity provider to authenticate entities. The relying party provides service(s) on the network and selectively grants access to the service(s) based on claims generated by the identity provider.

A claim generated by the identity provider may be based on a management policy rule, for example. For instance, the management policy rule may correlate a relationship between an entity and a service with access rights assigned to that relationship. In one aspect, a claim may include a management policy rule that specifies the access rights of an entity. In another aspect, a claim may include a reference indicator that references a management policy rule stored at a relying party that specifies the access rights of the entity. In accordance with this aspect, the reference indicator is said to specify the access rights of the entity. For instance, the relying party may be configured to store management policy rules that are generated by the identity provider, so that the identity provider may thereafter provide a claim including a reference indicator that references one or more of the management policy rules stored at the relying party, rather than providing the management policy rule(s) themselves.

Upon receiving a claim from the identity provider, the relying party may review a management policy rule that is included or referenced in the claim to determine whether the entity is authorized to utilize service(s) provided by the relying party. For instance, if the claim includes a reference indicator that references the management policy rule, the relying party may match the reference indicator to the management policy rule stored at the relying party to determine the access rights of the entity. Accordingly, the example structural components and corresponding functionality of the claims-based identity metasystem described above may be used to control access of an entity to a service provided by a relying party.

Example embodiments are capable of centralizing authentication and authorization functionality at an identity provider, rather than distributing the functionality among the identity provider and relying parties. The identity provider may provide an indication of an entity's access rights to a relying party upon authentication of the entity to enable the relying party to determine whether the entity is authorized to access service(s) provided by the relying party. For instance, the indication may indicate that the entity is authorized (or not authorized) to access a designated capability of the service(s). Example capabilities include but are not limited to hiring an employee, firing an employee, updating customer accounts, creating new customer accounts, etc. In at least some example embodiments, the identity provider is capable of utilizing management policy rules to determine the access rights of the entity based on a relationship between a set of entities that includes the entity and a set of relying parties that includes the relying party.

The identity provider may be configured to generate claims that include work flow definitions designating steps that may be performed by an entity in order for the entity to obtain authorization to access service(s) provided by the relying party. In an example embodiment, the identity provider provides an indication of a workflow definition to the relying party, so that the relying party can inform the entity of the steps that may be performed to obtain authorization to access the service(s) of the relying party. For instance, the relying party may inform the entity of the steps in response to the entity being denied access to the service(s). In another example embodiment, the identity provider provides the indication of the workflow definition directly to a client (e.g., a Web browser, Web crawler, or other type of client) for display to the entity. The indication may include both open readable elements and encrypted elements, such that the client may read and take action with respect to the open readable elements, for example by validating that the authenticity and the source of the open readable elements correspond to the identity provider using public key cryptography. For instance, while the client may be able to read the open readable elements, the client may not be able to modify the encrypted elements.

According to an embodiment, the relying party sets a threshold (e.g., specified criteria) that may be compared to the access rights of the entity with respect to a service. If the access rights meet the threshold, the relying party grants the entity access to the service. Otherwise, the relying party does not grant the entity access to the service. Accordingly, authentication and authorization functionality is centralized at the identity provider, such that the identity provider determines the access rights of the entity with respect to the service. The identity provider provides an indication of the entity's access rights to the relying party upon authentication of the entity, so that the relying party may determine whether the entity is authorized to access the service.

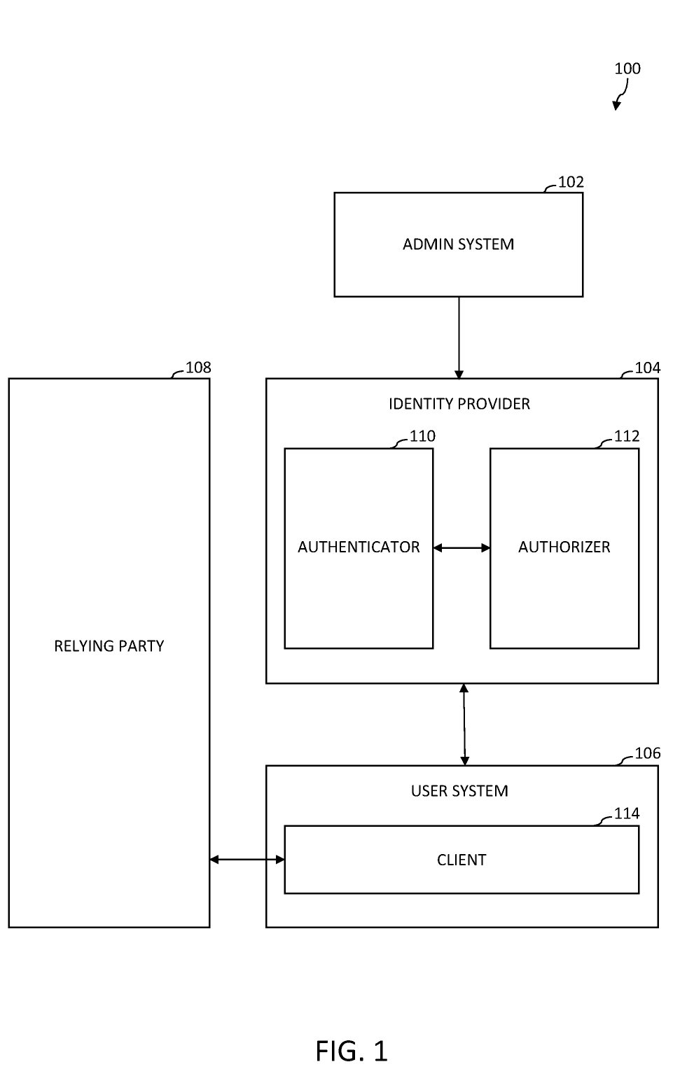

FIG. 1 is a block diagram of an example claims-based identity metasystem 100 in accordance with an embodiment. Metasystem 100 includes an administration (admin) system 102, an identity provider 104, a user system 106, and a relying party 108. Communication among admin system 102, identity provider 104, user system 106, and relying party 108 may be carried out over a wide area network, such as the Internet, using well-known network communication protocols. Additionally or alternatively, the communication may be carried out over a local area network (LAN) or another type of network.

Admin system 102 is a computer or other processing system including one or more processors that enables an authenticator 110 and an authorizer 112 of identity provider 104 to perform respective authentication and authorization functions with respect to an entity that is attempting to access a service provided by relying party 108. Authentication data is information pertaining to the identity of an entity. For example, admin system 102 may provide authentication data to be used by authenticator 110 during a subsequent authentication operation performed with respect to the entity. Authorization data is information pertaining to the access rights of an entity with respect to at least one service provided by the relying party. In another example, admin system 102 may provide authorization data to be used by authorizer 112 during a subsequent authorization operation performed with respect to the entity. An entity may be a user who owns or otherwise has access to user system 106 or an application that is running on user system 106. Example services include but are not limited to access to or use of a Web site, a software application, a database of information, etc.

User system 106 is a computer or other processing system including one or more processors that is capable of communicating with identity provider 104 and relying party 108 via a client 114 (e.g., a Web browser, Web crawler, or other type of client) deployed on user system 106. In an example embodiment, client 114 essentially acts as an intermediary between identity provider 104 and relying party 108 to facilitate the entity being authenticated and authorized to access the service that the entity is attempting to access. For instance, client 114 may send a request to relying party 108 on behalf of the entity, requesting access to a service provided by relying party 108. In another example embodiment, identity provider 104 communicates directly with relying party 108. For instance, identity provider 104 may provide an entity identity, other attributes of the entity, and/or information regarding the entity's access rights directly to relying party 108.

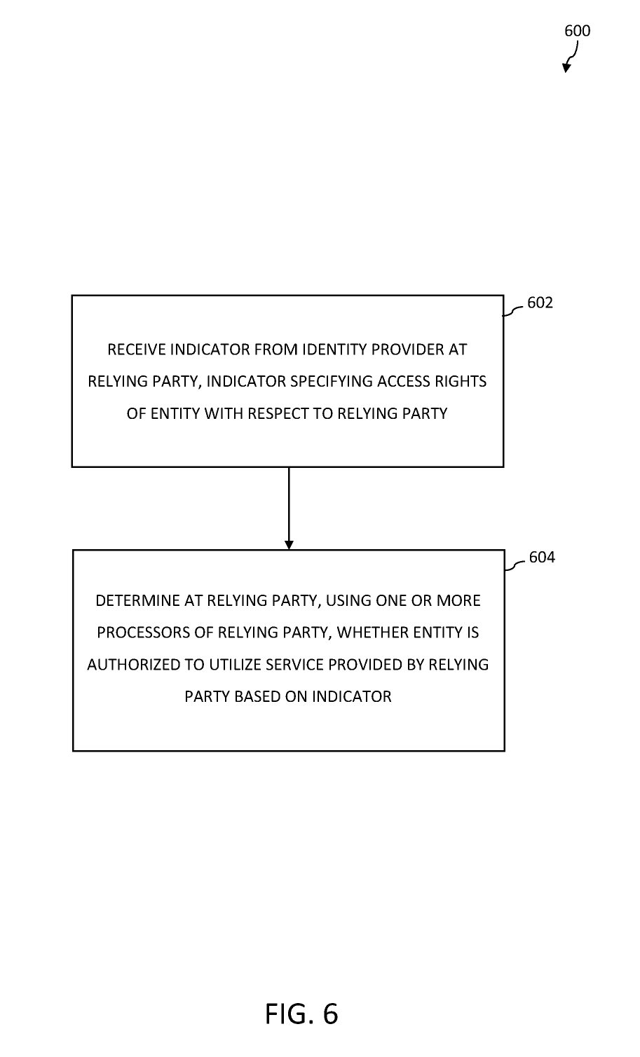

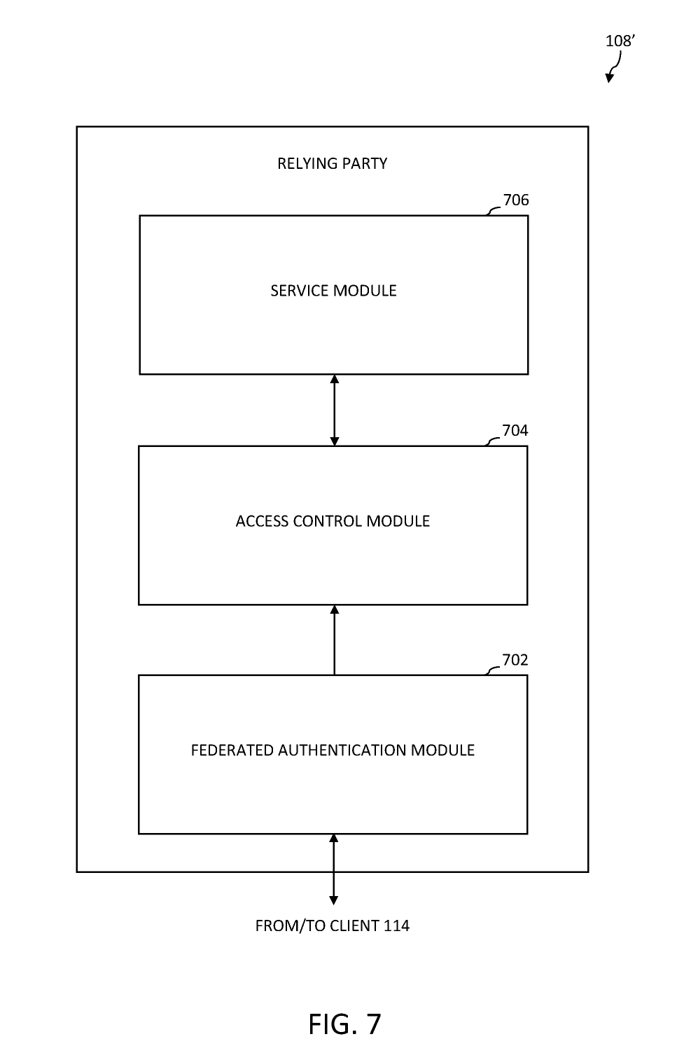

Relying party 108 is a computer (e.g., a server) or other processing system including one or more processors that relies on an identity provider to authenticate a user. Relying party 108 is configured to provide one or more services to the entity, so long as the entity is authenticated and authorized to access the service(s). Upon receiving the request from client 114, relying party 108 determines whether the entity has been authenticated and authorized. Techniques employed by relying party 108 for determining whether the entity has been authenticated and authorized are discussed in greater detail below with reference to FIGS. 6 and 7. If relying party 108 is able to verify that the entity has been authenticated and authorized, relying party 108 allows the entity to access the requested service. Otherwise, relying party 108 sends a response to client 114, requesting information indicating that the entity has been authenticated and authorized to access the service.

Identity provider 104 is a computer (e.g., a server) or other processing system including one or more processors that is configured to perform authentication and authorization functions with respect to entities that are attempting to access service(s) provided by relying party 108. Identity provider 104 includes an authenticator 110 for performing authentication functions and an authorizer 112 for performing authorization functions. In an example embodiment, authenticator 110 and authorizer 112 are implemented in respective applications, modules (e.g., software modules), computers or other processing systems, etc. In another example embodiment, authenticator 110 and authorizer 112 are combined into a single application, module (e.g., software module), computer or other processing system, etc. The authentication and authorization functions are described herein as being performed serially for illustrative purposes, though the scope of the example embodiments is not limited in this respect. Persons skilled in the relevant art(s) will recognize that the authentication and authorization functions may be performed partially or entirely in parallel.

Upon receiving the request for information from relying party 108, client 114 provides credentials associated with the entity to authenticator 110 for authentication. For instance, the credentials may be entered by a user via client 114, retrieved by client 114 from storage in user system 106 or elsewhere, generated by a security device possessed by the user, etc.

Authenticator 110 compares the credentials received from client 114 to authentication data stored in (or otherwise accessible to) authenticator 110 (e.g., authentication data received earlier from admin system 102) to authenticate the entity. If authenticator 110 is unable to authenticate the entity, authenticator 110 provides a notice to client 114, indicating that the authenticity of the entity is not verified. Client 114 may provide an interface to inform a user of user system 106 that access to the service is denied. For example, client 114 may indicate via the interface that the denial of access is based on a failure to authenticate the entity.

If authenticator 110 is able to authenticate the entity, however, authenticator 110 provides first information to authorizer 112, that indicates the entity (e.g., the identity of the entity). In an example embodiment, authenticator 110 provides second information to authorizer 112 that indicates the relying party or service thereof (e.g., the identity of the relying party or service thereof) that the entity is attempting to access, though it will be recognized that the relying party may provide the second information to authorizer 112. Authenticator 110 thereby performs authentication functions with respect to the entity.

Authorizer 112 compares the first and second information to authorization data stored in (or otherwise accessible to) authorizer 112 (e.g., authorization data received from admin system 102) to authorize the entity. If the comparison reveals that the entity is not authorized to access the service, authorizer 112 provides a notice to client 114, indicating that the entity is not authorized to access the service. Client 114 may provide an interface to inform a user of user system 106 that the entity is not authorized to access the service. In accordance with an embodiment, authorizer 112 may provide a reason that the entity is not authorized and/or instructions indicating the steps that may be taken for the entity to obtain authorization to access the service.

If authorizer 112 determines that the entity is authorized to access the service, authorizer 112 generates a claim for use by relying party 108 that includes an indicator specifying the access rights of the entity with respect to the service.

Authorizer 112 provides the claim containing the indicator to client 114, indicating that the entity is authorized to access the service. Authorizer 112 thereby performs authorization functions with respect to the entity. Techniques employed by authorizer 112 for performing authorization functions are discussed in greater detail below with reference to FIGS. 2, 4, and 5.

Upon receiving the claim containing the indicator from authorizer 112, client 114 provides the claim to relying party 108 in accordance with the request for information that relying party 108 provided to client 114 when the entity initially attempted to access the service provided by relying party 108. Relying party 108 compares the indicator to information stored in (or otherwise accessible to) relying party 108 to verify that the entity is authorized to access the service. Upon verifying that the entity is authorized to access the service, relying party 108 grants the entity access to the service.

In an example implementation of metasystem 100, the authorization data stored in (or otherwise accessible to) authorizer 112 includes a management policy rule that correlates a relationship between the entity and the service with access rights assigned to that relationship. For instance, authorizer 112 may be configured to determine the access rights based on the relationship between the entity and the service being correlated with the access rights. In accordance with this example implementation, authorizer 112 compares the information regarding the entity that is received from authenticator 110 to the management policy rule to determine the access rights of the entity with respect to the service. Moreover, authorizer 112 generates the claim, including the indicator that specifies the access rights of the entity with respect to the service, based on the management policy rule.

In another example implementation of metasystem 100, the validity of the indicator is time sensitive, meaning that the indicator is effective for a designated period of time after the indicator has been received by relying party 108. Relying party 108 stores information regarding the indicator for reference upon subsequent attempts by the entity to access the service. For example, if the entity attempts to access the service within the period designated for the indicator, relying party 108 may grant the entity access to the service without requesting that information be provided to indicate that the entity is authenticated and authorized to access the service. Rather, upon recognizing that the previously received indicator remains valid, relying party 108 may grant the entity access to the service. If the entity attempts to access the service after the period of time designated for the indicator expires, relying party 108 may send a request to client 114, requesting information indicating that the entity has been authenticated and authorized. Relying party 108 may deny the entity access to the service unless the requested information is received by relying party 108.

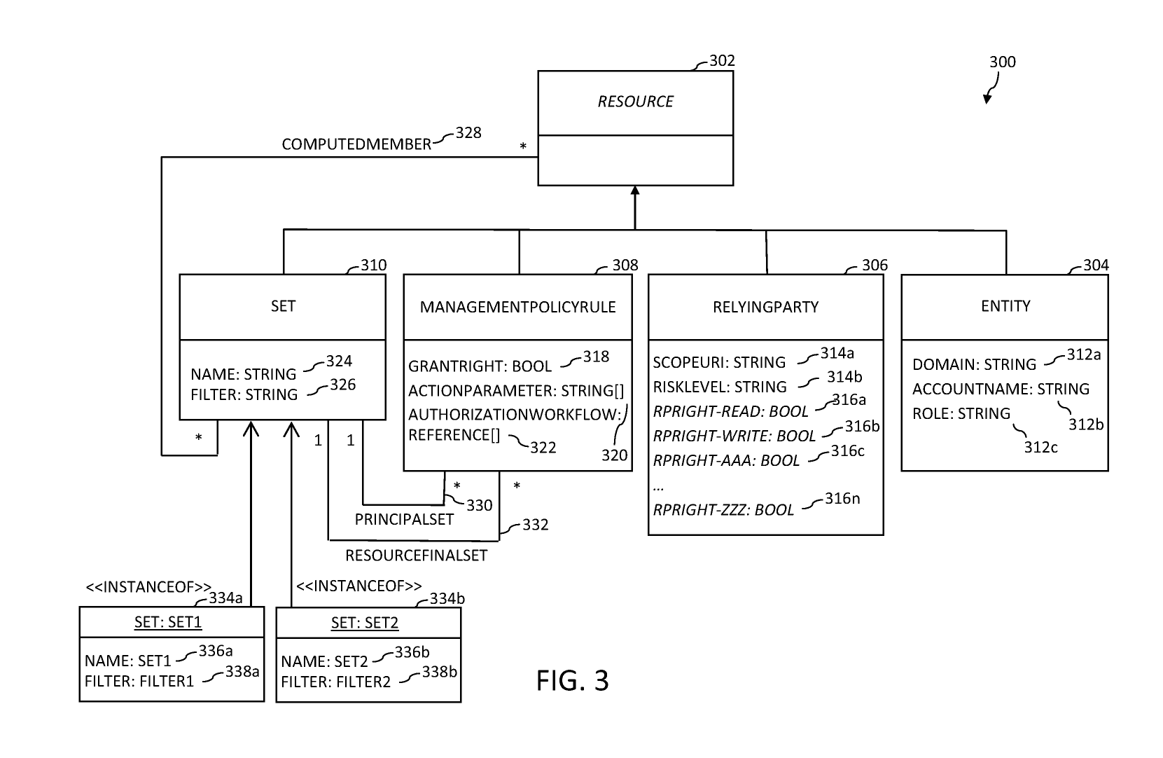

Even if the entity's attempt to access the service is within the designated period or relying party 108 receives the requested information following an attempt by the entity to access the service after the designated period, relying party may nevertheless deny the entity access to the service based on the access rights specified by the indicator failing to satisfy other condition(s). For instance, the indicator may specify attributes associated with the entity, which do not satisfy the requirements for access to the service. Some example attributes are discussed in greater detail below with reference to FIG. 3.

An example interaction between relying party 108 and identity provider 104 via client 114 will now be described for illustrative purposes and is not intended to be limiting. For purposes of discussion, relying party 108 is represented as a server, the service provided by relying party 108 is represented as access to an e-commerce Web site such as http://shopping.msn.com and associated functions, and the entity is represented as a user who interacts with the Web site through client 114. In accordance with this example interaction, the user attempts to access the e-commerce Web site using client 114. The server determines whether the user is currently authorized to access the Web site. For instance, the user may have previously accessed the Web site, and the previously verified access rights may still be valid. If the previously verified access rights are still valid, the server may grant the user access to the Web site. If the server has no currently valid record that the user is authorized to access the Web site, the server requests information from client 114 indicating the authenticity and authorization of the entity.

In example embodiments, client 114 determines which identity provider to contact for authentication and authorization of the entity by using a card selector application that is deployed on user system 106. A card selector application stores information cards pertaining to a user. An information card may include an identifier of the user and an authentication level of the credentials of the user, which may be specified by the user or an identity provider. Each information card corresponds to a respective identity provider, and may include references to the types of claims which the identity provider may generate. In response to the request from the server, the card selector application reviews the user's cards and determines which information cards indicate an authentication level of the user and claim types generated by the identity provider that satisfy the requirements specified in the server's request. The card selector application highlights the information card(s) that meet the requirements of the server's request. The user selects an information card from among the highlighted information card(s). In this example, the user selects the information card corresponding to identity provider 104 for illustrative purposes, though the user may select any highlighted information card.

An information card may be created by the user or an identity provider. If the information card is created by the user, the card selector application may act as an identity provider, such that the card selector application performs the authentication and authorization functions with respect to the user. Accordingly, user system 106 may include identity provider 104.

In response to the user selecting the information card corresponding to identity provider 104, client 114 contacts identity provider 104, which may be implemented in federation server or directory server applications, such as Identity Lifecycle Manager™ (ILM) developed by Microsoft Corporation; Sun Java System Federation Server™ developed by Sun Microsystems, Inc.; Oracle Identity Federation™ developed by Oracle Corporation; IBM® Tivoli® Federated Manager developed by International Business Machines Corporation (IBM); Samba™ open source framework originally developed by Andrew Tridgell, etc. running on server(s) or other computing system(s), though the scope of example embodiments is not limited in this respect.

Identity provider 104 performs operations to authenticate the user based on the credentials included in the information card selected by the user. Identity provider 104 also performs operations to authorize the user. For instance, identity provider 104 generates a first claim specifying the user's access rights with respect to the Web site. Identity provider 104 incorporates the first claim into an encrypted and signed token, which identity provider 104 provides to client 114. The token is encrypted and signed by identity provider 104 to enable relying party 108 to ensure the validity and authenticity of the token. It should be noted that the token need not necessarily be encrypted and/or signed. Identity provider 104 may generate a second claim specifying the steps that the user may take to obtain access to the Web site. For instance, identity provider 104 may be configured to include the second claim in the token in response to determining that the user is not authorized to access the Web site.

Client 114 forwards the token to the server. The server decrypts the token to determine the user's access rights, which are specified by the first claim. If the user's access rights indicate that the user is authorized to access the Web site, the relying party allows the user to access the Web site. Otherwise, the relying party denies the user access to the Web site.

If the server denies the user access to the Web site, the server may inform the user via client 114 that the user must be a member of the Web site, for example, in order to access the Web site, based on information included in the second claim. The server may further indicate the steps that may be performed to become a member of the Web site. For instance, the user may be presented with a Web page via client 114 stating, “Click here to become a member of msn.com.” If the user completes the process of becoming a member of the Web site, client 114 may notify identity provider 104 that the user is currently a member. For example, client 114 may notify identity provider 104 using an indicator that identifies the user and that specifies a membership status associated with the user.

Identity provider 104 may revise an existing claim or provide a new claim to include updated access rights indicating that the user is authorized to access the Web site. If client 114 subsequently contacts identity provider 104 at the request of the server for purposes of obtaining the user's authentication and authorization information, identity provider 104 may be configured to provide the revised or new claim, including the updated access rights. When client 114 forwards the revised or new claim to the server, the server may determine that the user is authorized to access the Web site based on the revised or new claim, and the server may grant the user access to the Web site.

FIG. 2 is a block diagram 200 of an example implementation of identity provider 104 shown in FIG. 1 in accordance with an embodiment. As shown in FIG. 2, identity provider 104′ includes authenticator 110′ and authorizer 112′. In this document, whenever a prime is used to modify a reference number, the modified reference number indicates an example implementation of the element that corresponds to the reference number. For example, identity provider 104′, authenticator 110′, and authorizer 112′ are example implementations of identity provider 104, authenticator 110, and authorizer 112, respectively.

Authenticator 110′ includes an authentication module 202 and an authentication database 204. Authentication module 202 is configured to authenticate an entity that is attempting to access a service provided by a relying party (e.g., relying party 108). Authentication module 202 receives credentials 220 via a link 214 from client 114. Authentication module 202 is configured to compare credentials 220 to authentication data stored in authentication database 204. Credentials 220 may include a username, password, or other identifying information associated with the entity. Authentication database 204 is configured to store the authentication data that is utilized by authentication module 202 for authenticating the entity.

If authentication module 202 is unable to authenticate the entity, authentication module 202 provides a notification to client 114, indicating that the authenticity of the entity is not verified. Otherwise, authentication module 202 provides an identifier 216 to security token service module 206. Identifier 216 identifies the entity and the relying party that the entity is attempting to access. It is noted that identifier 216 need not include a password or certain other security credential information associated with the entity. For example, identifier 216 may merely include a username or other information sufficient to identify the entity, along with information sufficient to identify the relying party that the entity is attempting to access. In another example, identifier 216 may identify the service of the relying party that the entity is attempting to access.

Authorization database 208 is configured to store access rights for each of a plurality of entities with respect to a plurality of services. Accordingly, authorization database 208 stores access rights associated with the entity regarding the services that the entity is allowed to access. Security token service module 206 compares identifier 216 to the access rights stored in authorization database 208 to determine whether the entity is authorized to access one or more services of the relying party.

If security token service module 206 determines that the entity is authorized to access one or more services provided by relying party 108, for example, security token service module 206 generates a rights claim. A rights claim is a claim that indicates access rights of an entity with respect to service(s) of a relying party. In this example, the rights claim generated by security token service module 206 indicates the access rights of the entity with respect to the one or more services provided by relying party 108. Security token service module 206 may be configured to generate a token that includes the rights claim. For instance, security token service module 206 may encrypt the token, sign the token, and provide the token to client 114, which may then forward the token to relying party 108 for further processing.

Security token service module 206 may include other claims in the token that is provided to client 114. For instance, security token service module 206 may include a workflow claim. A workflow claim is a claim that includes a workflow definition. A workflow definition defines a workflow by indicating steps that a user may take for the entity to obtain authorization to access the service provided by relying party 108. For instance, security token service module 206 may include the workflow claim in the token in response to security token service module 206 determining that the entity is not authorized to access the service.

Self-service module 212 is configured to enable an entity to perform the steps indicated by a workflow definition in a workflow claim generated by security token service module 206 in order to obtain authorization to access a service provided by a relying party (e.g., relying party 108). For instance, if the entity that is attempting to access the service provided by relying party 108 is denied access to that service, relying party 108 may specify the steps for obtaining access to the service along with the denial of access. The entity may perform the steps using self-service module 212 via client 114. If these steps are successful, then subsequently, when the entity next attempts to access services provided by relying party 108, security token service module 206 may generate a rights claim that indicates the revised access rights of the entity with respect to those services.

Self-service module 212 may use authentication module 202 and security token service module 206 to respectively authenticate and authorize the entity with respect to self-service module 212. For instance, authentication module 202 may authenticate the entity based on authentication data stored in authentication database 204.

Self-service module 212 provides authorization updating services, which enable entities to authorize themselves with respect to services that are provided by relying parties, such as relying party 108 of FIG. 1. The access rights stored in authorization database 208 may include access rights associated with the entity regarding the authorization updating services provided by self-service module 212.

When an entity attempts to access the authorization updating services provided by self-service module 212, self-service module 212 provides identifying information regarding the entity to authorization database 208 via provisioning module 210.

Security token service module 206 compares the identifying information provided by self-service module 212 to the access rights stored in authorization database 208 to determine whether the entity is authorized to access the authorization updating services provided by self-service module 212. In an example implementation, security token service module 206 builds a token 218 and treats self-service module 212 as a relying party with respect to security token service module 206. In accordance with this example implementation, security token service module 206 provides the token 218 to self-service module 212, enabling self-service module 212 to determine whether the entity is authorized to access the authorization updating services provided by self-service module 212.

Assuming the entity is granted access to the authorization updating services provided by self-service module 212, the entity is allowed to perform the steps indicated by the workflow definition for obtaining access to relying party 108 using self-service module 212 via client 114. When the steps indicated by the workflow definition have been completed, self-service module 212 provides an indicator to provisioning module 210, indicating that the steps have been completed. Self-service module 212 thereby enables the entity to perform the steps indicated by the workflow definition in the workflow claim generated by security token service module 206 in order to obtain authorization to access a service provided by relying party 108.

Provisioning module 210 is configured to update authorization information stored in authorization database 208 when access rights pertaining to relying parties change. Accordingly, when provisioning module 210 receives the indicator from self-service module 212, provisioning module 210 updates the authorization data of the entity that is stored in authorization database 208 to reflect that the entity is authorized to access the service.

In an example implementation, provisioning module 210 generates a management policy rule statement for storage in authorization database 208, indicating that the entity is authorized to access the service. In another example implementation, provisioning module 210 updates a set definition, corresponding to a set that includes entities authorized to access the service provided by a relying party (e.g., relying party 108 of FIG. 1), to include the entity that has been authorized as a result of completion of the steps indicated by the workflow definition. In yet another example implementation, provisioning module 210 updates a representation of the entity in authorization database 208 with changes to the attributes of the entity that has been authorized as a result of the steps indicated by the workflow definition being completed. In still another example implementation, provisioning module 210 updates a representation of the relying party in authorization database 208 with changes to the attributes of the relying party to include a reference indicator that references the entity that has been authorized as a result of completion of the steps indicated by the workflow definition. Management policy rules, sets, and the representation of entities and relying parties in an authorization database are described in further detail below with reference to FIG. 3.

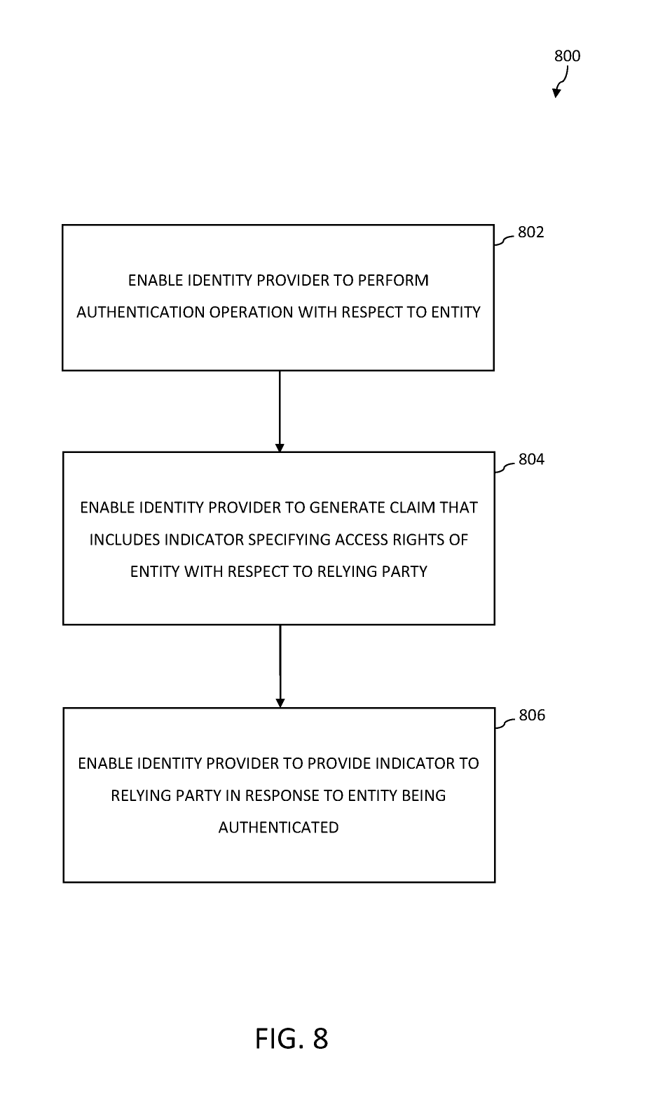

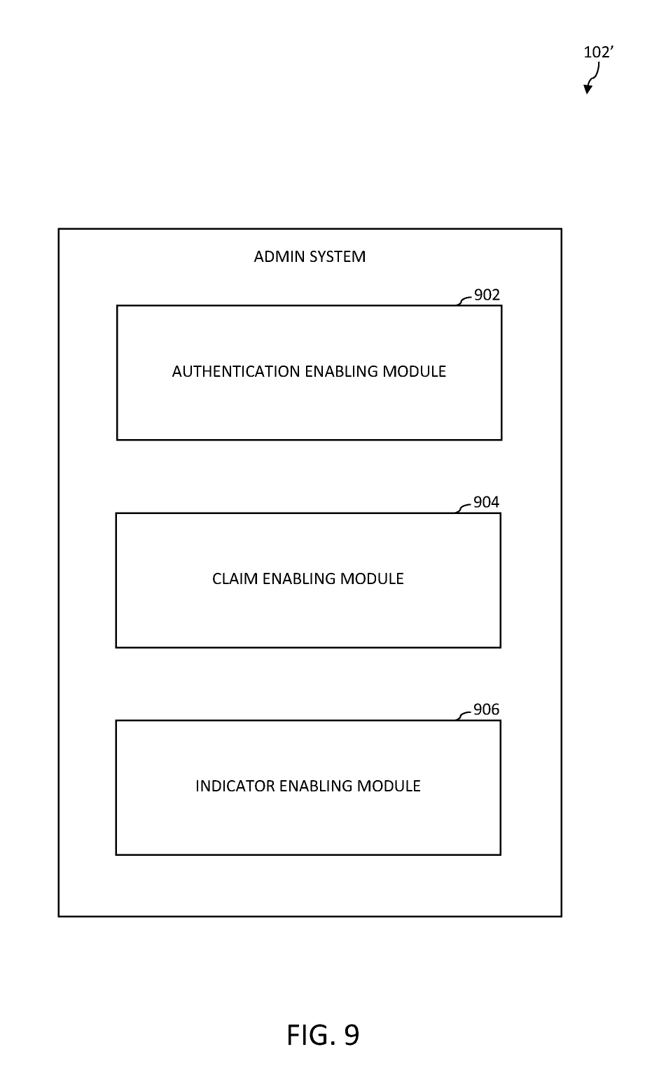

Provisioning module 210 may be used by an admin system (e.g., admin system 102 of FIG. 1) to enable identity provider 104′ to perform the authentication and authorization functions described herein. For example, provisioning module 210 may configure authentication module 202, authentication database 204, security token service module 206, authorization database 208, and/or self-service module 212 for enabling respective aspects of the authentication and/or authorization functions in accordance with embodiments. Some aspects of the enabling functionality of the admin system are described in further detail below with reference to FIGS. 8 and 9.

FIG. 3 is a unified modeling language (UML) diagram 300 of an example data model of authorization database 208 shown in FIG. 2 in accordance with an embodiment. FIG. 3 is provided in the context of a relational database for illustrative purposes, though the scope of example embodiments is not limited in this respect. For instance, in the discussion of FIG. 3, reference is made to tables for the purpose of clarity and is not intended to be limiting. As shown in FIG. 3, UML diagram 300 includes a resource 302, an entity table 304, a relying party table 306, a management policy rule table 308, and a set table 310. The numeral “1” and the asterisk “*” that are provided at the ends of some lines in UML diagram 300 indicate a single element and one or more elements (e.g., a plurality of elements), respectively. For instance, asterisks that are provided at respective ends of the line between resource 302 and set table 310 indicate that a plurality of resources may be associated with a plurality of sets in set table 310.

Resource 302 represents an abstract base class in a relational database. Each of tables 304, 306, 308, and 310 corresponds to a respective data type associated with resource 302. For example, entity table 304 corresponds to an “entity” data type, relying party table 306 corresponds to a “relying party” data type, management policy rule table 308 corresponds to a “management policy rule” data type, and set table 310 corresponds to a “set” data type. Each of the data types are discussed in further detail below with reference to tables 304, 306, 308, and 310.

Entity table 304 includes a list of entities and attributes thereof. Attributes are often referred to as columns in the context of a relational database. A domain attribute 312a, an account name attribute 312b, and a role attribute 312c are shown in entity table 304 for illustrative purposes and are not intended to be limiting. For instance, entity table 304 need not necessarily include domain attribute 312a, account name attribute 312b, and/or role attribute 312c. Other example attributes in entity table 304 may include but are not limited to a password, a security identifier, an email address, a public key, or other information that may be used to identify and/or authenticate an entity (e.g., a user or a software application).

Relying party table 306 includes a list of relying parties and attributes thereof. A scope URI attribute 314a, a risk level attribute 314b, and categories 316a-316n are shown in relying party table 306 for illustrative purposes and are not intended to be limiting. For instance, relying party table 306 need not necessarily include scope URI attribute 314a, risk level attribute 314b, and/or any one or more of categories 316a-316n. Relying party table 306 may include any suitable attribute. Scope URI attribute 314a represents a uniform resource indicator (URI) associated with a relying party. The URI may include a uniform resource locator (URL) and/or a uniform resource name (URN). The URI may indicate the location of the relying party within a computer network, for example.

Risk level attribute 314b represents the relative business risk to an enterprise that includes the relying party if the services provided by the relying party are compromised. For instance, risk level attribute 314b may specify a relatively low risk level, a relatively moderate risk level, or a relatively high risk level, though any suitable categorization of risk may be used. For example, a relatively low risk level may indicate inexpensive consequences for a company if the service is compromised. A relatively moderate risk level may indicate consequences that are moderately costly to the company if the service is compromised. A relatively high risk level may indicate expensive consequences for the company if the service is compromised. The risk level specified by risk level attribute 314b need not necessarily correspond to a cost to a company if a service is compromised. For instance, the risk level may correspond to the likelihood of reputational harm to one or more persons if the service is compromised. In an embodiment, the risk level or risk level attribute is a value that represents a combination of different risks or risk assessments.

Risk level attribute 314b may be used by an identity provider (e.g., identity provider 104) to determine access rights of an entity with respect to a service provided by a relying party (e.g., relying party 108). In an example implementation of a metasystem (e.g., metasystem 100), a first relying party has attributes indicating that the first relying party is a data sharing Web site, that the first relying party has “read” and “write” rights, that the first relying party is associated with a relatively low risk level, etc. A second relying party has attributes indicating that the second relying party is a human resources software application, that the second relying party has rights pertaining to hiring employees, firing employees, and changing a stock allocation associated with an employee, that the second relying party is associated with a relatively high risk level, etc. An entity has access rights that grant access to services of a relying party that is associated with the relatively low risk level. In accordance with this example implementation, an identity provider determines that the entity is authorized to access the first relying party, which is associated with the relatively low risk level, but is not authorized to access the second relying party, which is associated with the relatively high risk level. For instance, the access rights of the entity satisfy the requirements for obtaining access to the first relying party but do not satisfy the requirements for obtaining access to the second relying party.

Categories 316a-316n are categories of attributes of a relying party. Each attribute that is included in a category 316 may describe an access right that may be granted (e.g., operations that may be performed) with respect to a service provided by a relying party (e.g., relying party 108 of FIG. 1).

Set table 310 includes a list of attributes corresponding to sets of resources (e.g., entities or relying parties). Each set groups resources that have common values for the attributes listed in set table 310. A name attribute 324 and a filter attribute 326 are shown in set table 310 for illustrative purposes and are not intended to be limiting.

For instance, set table 310 need not necessarily include name attribute 324 and/or filter attribute 326. Set table 310 may include one or more other suitable attributes in addition to or in lieu of name attribute 324 and/or filter attribute 326. A filter defines a rule for which resources are in the scope of a set that corresponds to the filter. As shown in FIG. 3, “SET1” represents a first example instance 334a of the “SET” data type defined by set table 310. First instance 334a corresponds to a first name 336a and a first filter 338a. “SET2” represents a second example instance 334b of the “SET” data type defined by set table 310. Second instance 334b corresponds to a second name 336b and a second filter 338b. These example sets are shown as instances of set table 310 for illustrative purposes and are not intended to be limiting. Set table 310 may include any number of set(s), which may correspond to any suitable respective name(s) and/or filter(s).

“ComputedMember” 328 represents the relationship between the set and all resources within the scope of the filter definition. Sets facilitate the process of assigning rights to the groups of entities or relying parties having the common attribute(s). For instance, by assigning a right to a set, the right is applied to all of the entities or for all the relying parties in the scope of the set. As an example, if all vice presidents of a company are to have authorization to access financial data of the company, a filter definition may be built to group all users who are employees of the company having the role of vice president into a set. The access rights associated with that set may be configured to provide access to the financial data management service relying party to all users in the scope of that set. When an attribute of an entity or relying party changes, this may result in changes to the effective access rights. For example, an entity whose role changes may lose access rights to some relying parties and gain access rights to others. Subsequent attempts by that entity to authenticate will result in the identity provider generating revised claims or new claims with different access rights as compared to claims that were generated prior to the attribute of the entity or relying party changing.

Filter 324 may be represented as an extensible markup language (XML) path language expression (a.k.a. an XPath expression), which may be described as a Boolean logic expression of type value pairs. For example, the filter definition may be the XPath expression “/Entity[EmployeeType=‘full-time employee’]”. The set that is defined by this example XPath expression may include the entities having an attribute of “full-time employee.” In another example, the filter definition may be “/RelyingParty[Department=‘information technology’]”, indicating that the relying party is an information technology department, for example of a company or other organization.

Management policy rule table 308 includes management policy rules, which designate rights and/or workflows associated with relationships between sets of entities and sets of relying parties. The rights indicate which sets of entities are authorized to access which sets of relying parties. For instance, the “GrantRight” element 318 indicates whether a management policy rule grants access rights to a set of entities (referred to as “PrincipalSet”) with respect to a set of relying parties (referred to as “ResourceFinalSet”). The numeral “1” and the asterisk “*” that are provided at respective ends of lines 330 and 332 indicate that each set of entities and each set of relying parties in set table 310 may be associated with a plurality of management policy rules.

The “ActionParameter” element 320 indicates one or more categories 316 that are applicable to the set of entities that is associated with the management policy rule. The “AuthorizationWorkflow” element 322 designates one or more workflows. Each workflow indicates step(s) that may be performed for an entity to obtain access to a service provided by a relying party.

In a first example implementation of identity provider 104′ of FIG. 2 using the example data model depicted in FIG. 3, a management policy rule is used to determine whether an entity is authorized to access a service provided by a relying party. In accordance with this example implementation, if a user is attempting to access data sharing Web site #23, security token service module 206 of FIG. 2 may review the set memberships of the user that are stored in set table 310. The user may be a member of a first set that includes members of the basketball team, a second set that includes people who like cats and dogs, a third set that includes vice president, and so on.

Security token service module 206 may review attributes of data sharing Web site #23 that are stored in relying party table 306. For instance, a first attribute may indicate that data sharing Web site #23 is a data sharing Web site, a second attribute may indicate that data sharing Web site #23 is located in the eastern data center, and so on.

Security token service module 206 may review the management policy rules stored in management policy rule table 308 to find a rule pertaining to the relationship between the user and data sharing Web site #23. For instance, security token service module 206 may find a management policy rule designating that all vice presidents are authorized to access data sharing Web sites. Based on this management policy rule, security token service module 206 may determine that the user is authorized to access data sharing Web site #23.

In a second example implementation, a management policy rule is used to determine the steps of a workflow definition that may be performed for an entity to obtain authorization to access a service provided by a relying party. In accordance with this example implementation, if the relying party denies the entity access to the service, the relying party informs the entity of any steps specified by the management policy rule that the entity could follow to become authorized to access the service or resource of the relying party. The entity may perform the steps to become authorized to access the service, though approval by a third party (e.g., a manager of a user who is attempting to access the service or resource, an owner of a list that indicates entities having access to the service or resource, etc.) may be necessary for access to be granted to the entity. For example, a risk level associated with the service, which indicates the business risk to an enterprise if the service or resource is compromised, may determine whether approval by a third party is necessary to authorize the entity.

An administrative user may allocate security groups for providing access to services among sets corresponding to risk levels associated with the respective services. Each set may correspond to a respective management policy rule. For instance, a first set may include as members security groups for providing access to services having a relatively low risk level (e.g., applications facilitating scheduling people who are on the Frisbee golf team). The management policy rule applicable to the first set may specify that an entity is allowed to add itself to groups in the scope of the first set without obtaining approval from a third party.

A second set may include as members security groups for providing access to services having a relatively moderate risk level. The management policy rule applicable to the second set may specify that approval by a third party is necessary for an entity to obtain access to the groups in the scope of the second set. The third party may be an owner of the list, a manager of the entity, an executive in a company, etc. In such instance, self-service module 212 may send a request notification (e.g., an email, an instant message, etc.) to the third party, informing the third party that the entity is requesting to be added to a group in the scope of the second set. If the third party approves the request to add the entity, self-service module 212 may send an approval notification (e.g., an email, an instant message, etc.) to the entity, informing the entity that the entity has been added to group in the scope of the second set.

A third set may include as members security groups for providing access to services having a relatively high risk level (e.g., providing access to trade secrets of a company). The management policy rule applicable to the third set may specify that an entity is not allowed to request to add itself to groups in the scope of the third set, even with the approval of a third party.

The UML diagram 300 of FIG. 3 is one example data model that may be used to describe authorization database 208 shown in FIG. 2. Persons skilled in the relevant art(s) will recognize that authorization database 208 may be described using other data models.

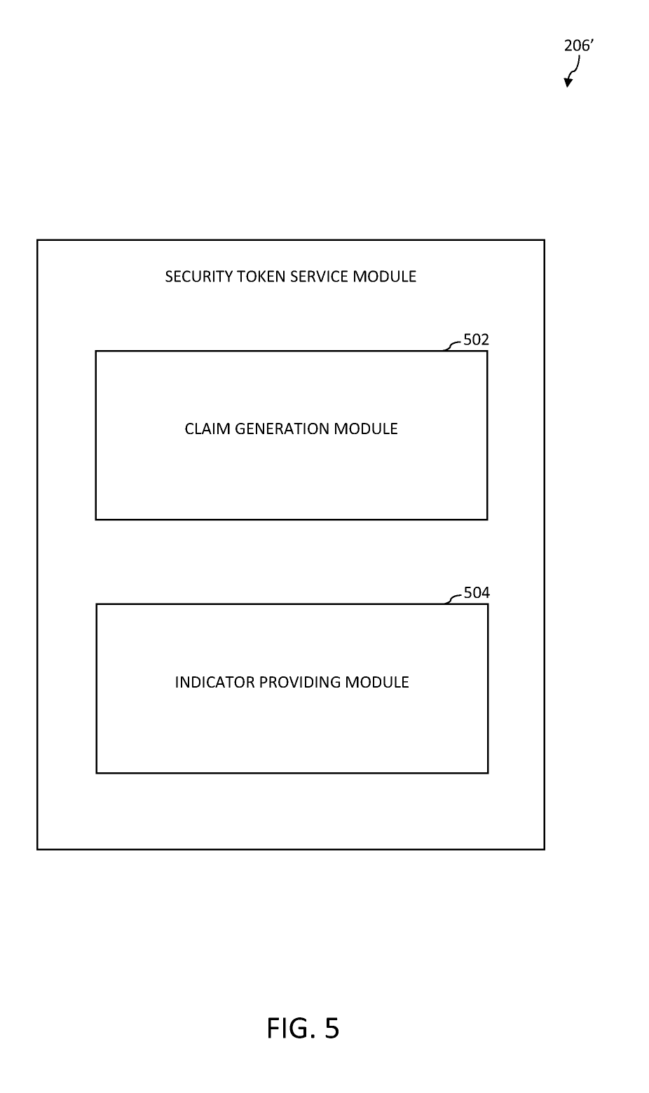

FIG. 4 depicts a flowchart 400 of a method for performing claims-based authorization in accordance with an embodiment. Flowchart 400 is described from the perspective of an identity provider. Flowchart 400 may be performed by security token service module 206 of identity provider 104′ shown in FIG. 2, for example. For illustrative purposes, flowchart 400 is described with respect to a security token service module 206′ shown in FIG. 5, which is an example of security token service module 206, according to an embodiment. As shown in FIG. 5, security token service module 206′ includes a claim generation module 502 and an indicator providing module 504. Further structural and operational embodiments will be apparent to persons skilled in the relevant art(s) based on the discussion regarding flowchart 400. Flowchart 400 is described as follows.

As shown in FIG. 4, the method of flowchart 400 begins at step 402. In step 402, a claim is generated at an identity provider using one or more processors of the identity provider. The claim includes a first indicator specifying access rights of an entity with respect to a service provided by a relying party. The claim may be generated based on a management policy rule, as described above with reference to FIG. 3, for example. For instance, the management policy rule may correlate a relationship between the entity and the service with access rights assigned to that relationship. In one aspect, the first indicator may include a management policy rule that specifies the access rights of the entity. In another aspect, the first indicator may include a reference indicator that references a management policy rule stored at the relying party that specifies the access rights of the entity. In accordance with this aspect, the reference indicator is said to specify the access rights of the entity. For instance, the relying party may be configured to store rule sets that are generated by the identity provider, so that the identity provider may thereafter provide the first indicator including a reference indicator that references a management policy rule included in the rule sets, rather than the management policy rule itself.

It will be recognized that the first indicator may include both management policy rule(s) and reference indicator(s) that specify access rights of the entity. The first indicator may specify that the entity is (or is not) authorized to access one or more services of the relying party. In an example implementation, claim generation module 502 generates the claim that includes the first indicator in accordance with step 402.

At step 404, if a workflow definition is available that designates at least one operation for the entity to perform, a second claim may be generated at the identity provider that includes a second indicator specifying the workflow definition designating the at least one operation that the user may perform to qualify for access to the service provided by the relying party. In an example implementation, claim generation module 502 generates the second claim that includes the second indicator. Step 404 may not be performed in some embodiments. For instance, the second claim may not be generated if there is no appropriate workflow definition or if the admin system does not permit self service for the entity.

At step 406, the first indicator is provided to the relying party to enable the relying party to determine whether the entity is authorized to utilize a service provided by the relying party. For example, upon receiving the first indicator, the relying party may review a management policy rule that is included in the first indicator to determine whether the entity is authorized to utilize the service. In another example, the first indicator may include a reference indicator that references a management policy rule stored at the relying party. In accordance with this example, the relying party may match the reference indicator to the management policy rule stored at the relying party to determine the access rights of the entity. For instance, the management policy rule may specify that entities having a designated role are authorized to utilize a service. The relying party may determine that the entity is authorized to utilize the service because the entity has the designated role.

The first indicator that is provided at step 406 may include any number of management policy rules and/or reference indicators. The relying party may determine whether the entity is authorized to utilize the service provided by the relying party based on any one or more of the management policy rule(s) included and/or referenced in the first indicator. Management policy rules that are stored at the relying party may take precedence over management policy rules that are included in the first indicator, or vice versa. For instance, if a conflict exists between such management policy rules, the relying party may determine whether the entity is authorized to utilize the service based on management policy rule(s) stored at the relying party, as opposed to management policy rule(s) that are included in the first indicator, or vice versa.

The relying party may be capable of dynamically modifying management policy rules that are stored at the relying party. If an authorization change is desired without incurring a potential delay associated with requesting and receiving an updated management policy rule from the identity provider, for example, the relying party may modify a management policy rule stored at the relying party to include the authorization change. Such an authorization change may include but is not limited to a change in access rights regarding an entity or a service, a change in a time interval for which the management policy rule is valid, etc. A management policy rule that is stored at the relying party may include a list of entities, URIs, patterns of access requests, etc. for which access to a service is to be denied.

In an example implementation, indicator providing module 504 provides the first indicator to the relying party. In accordance with this example implementation, indicator providing module 504 may provide a token generated by claim generation module 502 to the relying party. For instance, the token may include the first indicator as a value of a claim carried within an encrypted and/or signed token.

At step 408, the second indicator, if generated, may be provided to the relying party to enable the relying party to inform the entity of the workflow definition designating the at least one operation in response to the entity being denied access to the service provided by the relying party. In an example implementation, indicator providing module 504 provides the second indicator to the relying party. For instance, claim generation module 502 may generate a token that includes the first claim that indicates the access rights of the entity with respect to the service provided by the relying party and the second claim that indicates the workflow definition. It should be noted that generating the second claim that includes the second indicator and providing the second indicator to the relying party, as described with reference to steps 404 and 408, are optional, for example are included if workflow definitions are available or applicable, and/or can be included in some embodiments, and omitted in others. In an example embodiment, one or more of steps depicted in FIG. 4 are omitted. For instance, steps 404 and/or 408 may be omitted.

FIG. 6 depicts a flowchart 600 of a method for verifying authorization in accordance with an embodiment. Flowchart 600 is described from the perspective of a relying party. Flowchart 600 may be performed by relying party 108 of claims-based identity metasystem 100 shown in FIG. 1, for example. For illustrative purposes, flowchart 600 is described with respect to a relying party 108′ shown in FIG. 7, which is an example of relying party 108, according to an embodiment. As shown in FIG. 7, relying party 108′ includes a federated authentication module 702, an access control module 704, and a service module 706. Further structural and operational embodiments will be apparent to persons skilled in the relevant art(s) based on the discussion regarding flowchart 600. Flowchart 600 is described as follows.

As shown in FIG. 6, the method of flowchart 600 begins at step 602. In step 602, an indicator is received at a relying party from an identity provider via, for example, a client, or from the identity provider via a direct or indirect link that bypasses a user system (e.g., user system 106). The indicator specifies access rights of an entity with respect to the relying party. In an example implementation, federated authentication module 702 of relying party 108′ receives the indicator specifying the access rights of the entity. For instance, federated authentication module 702 may receive a token that includes the indicator. Federated authentication module 702 may decrypt the token in order to review and/or authenticate the indicator.

In an example implementation, federated authentication module 702 sets a cookie in a client (e.g., client 114 of FIG. 1) to store information regarding the entity, such as a designated time period during which the entity is deemed to be authenticated, an indicator (e.g., an encrypted index to a data structure) corresponding to the session in which the entity is attempting to access a service provided by the relying party, an indicator specifying an epoch (e.g., a time at which the service started), etc. For instance, the time period during which the entity is deemed to be authenticated may be 30 seconds, 5 minutes, 1 hour, 2 days, or any other suitable time period. When the entity attempts to access a service provided by relying party 108′, federated authentication module 702 checks the information stored in the cookie. For instance, federated authentication module 702 may check to determine whether a time period regarding the entity's authenticity has expired. If the time period has expired, federated authentication module 702 may send a request to the client, requesting information regarding the authenticity of the entity. Otherwise, flow continues to step 604.

At step 604, a determination is made at the relying party, using one or more processors of the relying party, as to whether the entity is authorized to utilize a service provided by the relying party based on the indicator. In an example implementation, access control module 704 determines whether the entity is authorized to utilize the service. For instance, access control module 704 may compare the indicator or information associated therewith to zero or more rules stored in access control module 704 to determine whether the entity is authorized to utilize the service. The rule(s) may be derived from an indicator previously received from the identity provider, for example. The indicator may be compared to zero rules when, for example, the entity is authenticated but does not have access to services of the relying party. In accordance with this example, an authorization claim associated with the entity may be empty, but another claim containing a second indicator may exist that includes a workflow definition.

Service module 706 is configured to provide services of relying party 108′.

For example, if access control module 704 determines that the entity is authorized to access the service that the entity is attempting to access, access control module 704 enables the entity to access the service via service module 706. Otherwise, access control module 704 does not enable the entity to access the service.

FIG. 8 depicts a flowchart 800 of a method for facilitating the centralization of authentication and authorization functionality at an identity provider in accordance with an embodiment. Flowchart 800 is described from the perspective of an admin system. Flowchart 800 may be performed by admin system 102 of claims-based identity metasystem 100 shown in FIG. 1, for example. For illustrative purposes, flowchart 800 is described with respect to an admin system 102′ shown in FIG. 9, which is an example of admin system 102, according to an embodiment. As shown in FIG. 9, admin system 102′ includes an authentication enabling module 902, a claim enabling module 904, and an indicator enabling module 906. Further structural and operational embodiments will be apparent to persons skilled in the relevant art(s) based on the discussion regarding flowchart 800. Flowchart 800 is described as follows.

As shown in FIG. 8, the method of flowchart 800 begins at step 802. In step 802, an identity provider is enabled to perform an authentication operation with respect to an entity. In an example implementation, authentication enabling module 902 of admin system 102′ enables the identity provider to perform the authentication operation. For instance, authentication enabling module 902 may configure an authenticator (e.g., authenticator 110 of FIG. 1) to perform the authentication operation. Authentication enabling module 902 may provide authentication data to an authentication database (e.g., authentication database 204 of FIG. 2), for example, so that an authentication module (e.g., authentication module 202 of FIG. 2) may compare the authentication data to information received from the client for authentication of the entity.

At step 804, the identity provider is enabled to generate a claim that includes an indicator specifying access rights of the entity with respect to a relying party. In an example implementation, claim enabling module 904 enables the identity provider to generate the claim. For instance, claim enabling module 904 may enable a security token service module (e.g., security token service module 206 of FIG. 2) to generate the claim. In accordance with this example implementation, claim enabling module 904 may provide authorization data to an authorization database (e.g., authorization database 208 of FIG. 2), so that the security token service module may generate the claim based on the authorization data. The authorization data may include a management policy rule associating the access rights with an authorization level of the entity with respect to a service provided by the relying party.

Claim enabling module 904 may enable the security token service module to incorporate the claim into a token. For example, claim enabling module 904 may configure the security token service module to perform an algorithm that incorporates the claim into the token. Claim enabling module 904 may configure the security token service module by modifying software code and/or circuitry of the security token service module. Claim enabling module 904 may enable the security token service module to encrypt the token and/or sign the token for transmission to the relying party via a client (e.g., client 114), for example. For instance, claim enabling module 904 may configure the security token service module to perform an algorithm to encrypt and/or sign the token. Encrypting and/or signing the token may hinder an entity from attempting to gain access by modifying the token, as a modified token may be detected by the relying party receiving it.

At step 806, the identity provider is enabled to provide the indicator to the relying party in response to the entity being authenticated. In an example implementation, indicator enabling module 906 enables the identity provider to provide the indicator to the relying party. For instance, indicator enabling module 906 may configure the security token service module to determine whether the entity is authenticated based on a notification received from an authentication module, such as authentication module 202 of FIG. 2. The notification specifies that the entity is authenticated or that the entity is not authenticated. Indicator enabling module 906 may configure the identity provider to provide the indicator to the relying party if the notification specifies that the entity is authenticated. Indicator enabling module 906 may configure the identity provider to not provide the indicator to the relying party if the notification specifies that the entity is not authenticated. Indicator enabling module 906 may configure the security token service module by modifying software code and/or circuitry of the security token service module. For instance, configuring the security token service module as described above may enable the entity to obtain access to a service provided by the relying party.

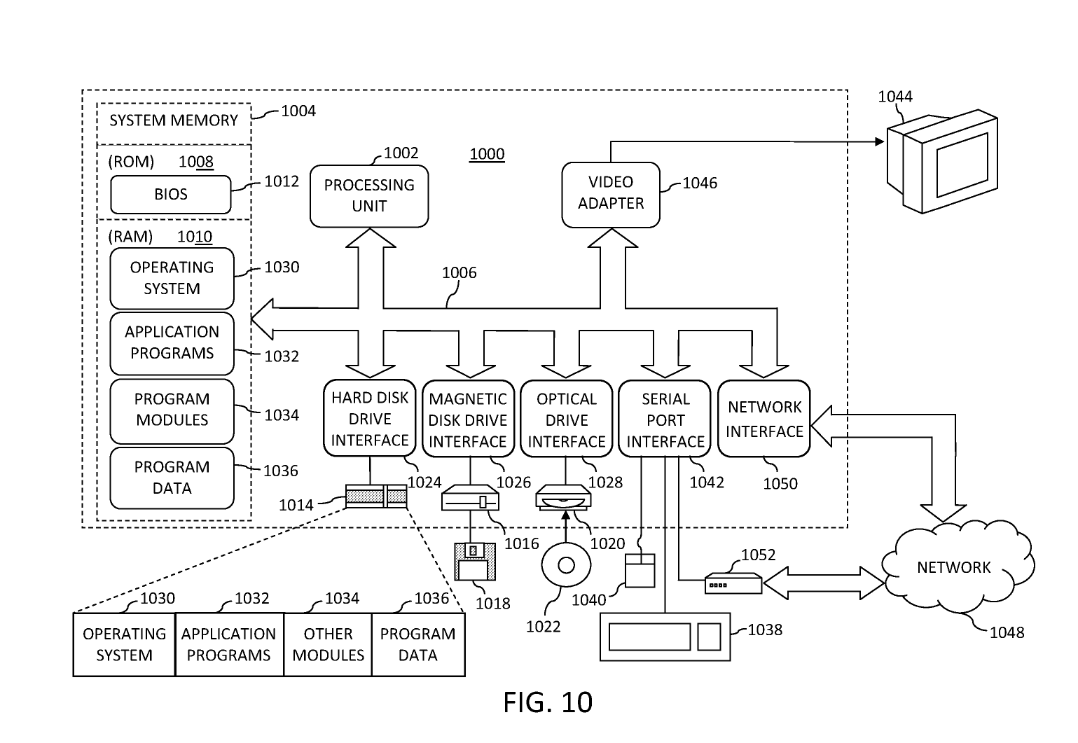

FIG. 10 depicts an example computer 1000 in which embodiments may be implemented. Any one or more of the admin system 102, identity provider 104, user system 106, relying party 108, authenticator 110, or authorizer 112 shown in FIG. 1 (or any one or more subcomponents thereof shown in FIGS. 2, 5, 7, and 9) may be implemented using computer 1000, including one or more features of computer 1000 and/or alternative features. Computer 1000 may be a general-purpose computing device in the form of a conventional personal computer, a mobile computer, or a workstation, for example, or computer 1000 may be a special purpose computing device. The description of computer 1000 provided herein is provided for purposes of illustration, and is not intended to be limiting. Embodiments may be implemented in further types of computer systems, as would be known to persons skilled in the relevant art(s).

As shown in FIG. 10, computer 1000 includes a processing unit 1002, a system memory 1004, and a bus 1006 that couples various system components including system memory 1004 to processing unit 1002. Bus 1006 represents one or more of any of several types of bus structures, including a memory bus or memory controller, a peripheral bus, an accelerated graphics port, and a processor or local bus using any of a variety of bus architectures. System memory 1004 includes read only memory (ROM) 1008 and random access memory (RAM) 1010. A basic input/output system 1012 (BIOS) is stored in ROM 1008.

Computer 1000 also has one or more of the following drives: a hard disk drive 1014 for reading from and writing to a hard disk, a magnetic disk drive 1016 for reading from or writing to a removable magnetic disk 1018, and an optical disk drive 1020 for reading from or writing to a removable optical disk 1022 such as a CD ROM, DVD ROM, or other optical media. Hard disk drive 1014, magnetic disk drive 1016, and optical disk drive 1020 are connected to bus 1006 by a hard disk drive interface 1024, a magnetic disk drive interface 1026, and an optical drive interface 1028, respectively. The drives and their associated computer-readable storage media provide nonvolatile storage of computer-readable instructions, data structures, program modules and other data for the computer. Although a hard disk, a removable magnetic disk and a removable optical disk are described, other types of computer-readable media can be used to store data, such as flash memory cards, digital video disks, random access memories (RAMs), read only memories (ROM), and the like.

A number of program modules may be stored on the hard disk, magnetic disk, optical disk, ROM, or RAM. These programs include an operating system 1030, one or more application programs 1032, other program modules 1034, and program data 1036. Application programs 1032 or program modules 1034 may include, for example, computer program logic for implementing authenticator 110, authorizer 112, client 114, authentication module 202, security token service module 206, provisioning module 210, self-service module 212, claim generation module 502, indicator providing module 504, federated authentication module 702, access control module 704, service module 706, authentication enabling module 902, claim enabling module 904, indicator enabling module 906, flowchart 400 (including any step of flowchart 400), flowchart 600 (including any step of flowchart 600), and/or flowchart 800 (including any step of flowchart 800), as described herein.

A user may enter commands and information into the computer 1000 through input devices such as keyboard 1038 and pointing device 1040. Other input devices (not shown) may include a microphone, joystick, game pad, satellite dish, scanner, or the like. These and other input devices are often connected to the processing unit 1002 through a serial port interface 1042 that is coupled to bus 1006, but may be connected by other interfaces, such as a parallel port, game port, or a universal serial bus (USB).

A monitor 1044 or other type of display device is also connected to bus 1006 via an interface, such as a video adapter 1046. In addition to the monitor, computer 1000 may include other peripheral output devices (not shown) such as speakers and printers.

Computer 1000 is connected to a network 1048 (e.g., the Internet) through a network interface or adapter 1050, a modem 1052, or other means for establishing communications over the network. Modem 1052, which may be internal or external, is connected to bus 1006 via serial port interface 1042.

As used herein, the terms “computer program medium” and “computer-readable medium” are used to generally refer to media such as the hard disk associated with hard disk drive 1014, removable magnetic disk 1018, removable optical disk 1022, as well as other media such as flash memory cards, digital video disks, random access memories (RAMs), read only memories (ROM), and the like.

As noted above, computer programs and modules (including application programs 1032 and other program modules 1034) may be stored on the hard disk, magnetic disk, optical disk, ROM, or RAM. Such computer programs may also be received via network interface 1050 or serial port interface 1042. Such computer programs, when executed or loaded by an application, enable computer 1000 to implement features of embodiments discussed herein. Accordingly, such computer programs represent controllers of the computer 1000.

Embodiments are also directed to computer program products comprising software (e.g., computer-readable instructions) stored on any computer useable medium. Such software, when executed in one or more data processing devices, causes a data processing device(s) to operate as described herein. Embodiments may employ any computer-useable or computer-readable medium, known now or in the future. Examples of computer-readable mediums include, but are not limited to storage devices such as RAM, hard drives, floppy disks, CD ROMs, DVD ROMs, zip disks, tapes, magnetic storage devices, optical storage devices, MEMS-based storage devices, nanotechnology-based storage devices, and the like.

Embodiments described herein have a variety of benefits, as compared to conventional system access management techniques. For example, embodiments may advantageously centralize authentication and authorization functionality at an identity provider. For instance, a relying party (e.g., a server) may need only to verify the identity provider's determination as to whether an entity (e.g., a user or a software application) is authorized to access the relying party. In accordance with embodiments, the identity provider may be configured to generate claims that indicate access rights of an entity with respect to a relying party. Embodiments are capable of utilizing management policy rules to determine the access rights of an entity based on a relationship between a set of entities that includes the entity and a set of relying parties that includes the relying party that the entity is attempting to access.

The identity provider may be configured to generate claims including work flow definitions designating steps that may be performed in order for an entity to obtain access to service(s) provided by a relying party. According to embodiments, the identity provider may provide an indication of the workflow definitions to the relying party, so that the relying party can inform the entity of the steps that may be performed to obtain access to the service(s) of the relying party if the entity is denied access to the service(s).

### III. CONCLUSION

While various embodiments have been described above, it should be understood that they have been presented by way of example only, and not limitation.

It will be apparent to persons skilled in the relevant art(s) that various changes in form and details can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method comprising:
generating a claim at an identity provider using one or more processors of the identity provider, the claim including an indicator that specifies access rights of a first entity with respect to a first relying party; and
providing the indicator to the first relying party to enable the first relying party to determine whether the first entity is authorized to utilize a service provided by the first relying party.

2. The method of claim 1, wherein the first entity is a user.

3. The method of claim 1, wherein the first entity is a software application.

4. The method of claim 1, wherein providing the indicator includes providing the indicator to the first relying party via a user system communicatively coupled between the identity provider and the first relying party.

5. The method of claim 1, further comprising:
authenticating the first entity at the identity provider;
wherein providing the indicator to the first relying party is performed in response to authenticating the first entity at the identity provider.

6. The method of claim 1, further comprising:
generating an encrypted token that includes the claim;
wherein providing the indicator includes providing the encrypted token to the first relying party.

7. The method of claim 1, further comprising:
determining the access rights of the first entity with respect to the first relying party based on a management policy rule that associates the access rights with a relationship between a set of entities that includes the first entity and a set of relying parties that includes the first relying party.

8. The method of claim 7, further comprising:
defining the set of entities based on a role associated with the entities.

9. The method of claim 7, further comprising:
defining the set of relying parties based on a risk level associated with the relying parties.

10. The method of claim 1, further comprising:
generating a second claim at the identity provider that includes a second indicator specifying a workflow definition designating at least one operation that when executed facilitates the first entity obtaining access to the service provided by the first relying party; and
providing the second indicator to the first relying party to enable the first relying party to inform the first entity of the workflow definition in response to the first entity being denied access to the service provided by the first relying party.

11. The method of claim 10, further comprising:
in response to performance of the at least one operation, generating a revised claim or a new claim at the identity provider, the revised claim or the new claim including a revised indicator that specifies revised access rights of the first entity with respect to the first relying party, the revised access rights indicating that the first entity is authorized to access the service provided by the first relying party.

12. The method of claim 1, further comprising:
generating a revised claim or a new claim at the identity provider, the revised claim or the new claim including a revised indicator that indicates revised access rights of the first entity with respect to the first relying party, in response to a change in an attribute of the first entity.

13. A method comprising:
receiving an indicator from an identity provider at a relying party, the indicator specifying access rights of an entity with respect to the relying party; and
determining at the relying party, using one or more processors of the relying party, whether the entity is authorized to utilize a service provided by the relying party based on the indicator.

14. The method of claim 13, wherein the entity is a user.

15. The method of claim 13, wherein the entity is a software application.

16. The method of claim 13, wherein receiving the indicator includes receiving the indicator at the relying party from the identity provider via a user system.

17. The method of claim 13, wherein receiving the indicator at the relying party is performed in response to the entity being authenticated by the identity provider.

18. An identity provider comprising:
an authentication module configured to authenticate an entity;
a claim generation module configured to generate a claim that includes an indicator that specifies access rights of the entity with respect to a relying party; and
an indicator providing module configured to provide the indicator to the relying party to enable the relying party to determine whether the entity is authorized to utilize a service provided by the relying party.

19. The identity provider of claim 18, wherein the claim generation module is further configured to generate a second claim that includes a second indicator specifying a workflow definition designating at least one operation that when executed facilitates the entity obtaining access to the service provided by the relying party; and
wherein the indicator providing module is further configured to provide the second indicator to the relying party to enable the relying party to inform the entity of the workflow definition.

20. The identity provider of claim 19, wherein the claim generation module is further configured to generate a revised claim or a new claim that includes a revised indicator that specifies revised access rights of the entity that authorize the entity to access the service provided by the relying party based on performance of the at least one operation.
